(19) United States
(12) Patent Application Publication
(10) Pub. No.: US 2009/0121577 A1
(43) Pub. Date: May 14, 2009

(54) Stator core, motor, and method of manufacturing stator

(75) Inventors: Kazutaka Tatematsu, Nagoya-shi (JP); Ryoji Mizutani, Nishikamo-gun (JP); Yasuhiro Endo, Okazaki-shi (JP)

Correspondence Address: OLIFF & BERRIDGE, PLC, P.O. BOX 320850, ALEXANDRIA, VA, 22320-4850, US

(73) Assignee: Toyota Jidosha Kabushiki Kaisha, Toyota-shi (JP)

(21) Appl. No.: 11/991,320

(22) PCT Filed: Sep. 8, 2006
(86) PCT No.: PCT/JP2006/318314

§ 371 Date: Feb. 29, 2008

(30) Foreign Application Priority Data
Sep. 9, 2005 (JP) 2005-261868

(51) Int. Cl. H02K 1/18; H02K 15/02

(52) U.S. Cl. 310/218; 29/596

(57) ABSTRACT

A stator core installed around the rotating shaft of a motor, comprising a plurality of split cores split in the circumferential direction. The split core is formed of a compressed powder magnetic core. To connect the split core to the adjacent split core, hole parts of rectangular parallelepiped shape are formed in the upper end surfaces thereof. A connection between the split cores is performed by press-fitting a clamp into the hole parts. As a result, the split stators can be compactly integrated with each other.

### TECHNICAL FIELD

The present invention relates to a technology related to the stator core of a motor, and more particularly to a technology of forming the stator core by using a compressed powder magnetic core.

### BACKGROUND ART

In one method for assembling a motor stator, the stator core is formed split, and the individual split cores are provided with a coil in order to facilitate winding of the coil and the like. JP-A 2004-328965 discloses a technology of assembling the stator by inserting the stator cores, which are split for each of teeth on which a coil is wound, into a cylindrical housing by press fitting or shrinkage fitting.

The technology described in JP-A 2004-328965 employs a large motor, because of a housing which is disposed separately. And, since a stress is applied to the stator core, magnetic characteristics are deteriorated, along with motor performance.

### DISCLOSURE OF THE INVENTION

The present invention has been conceived under the above circumstances, and an object thereof is to develop a new technology of forming a compact stator.

Another object of the present invention is to establish a technology of connecting adjacent split cores without applying a stress to the split cores as a whole.

Still another object of the present invention is to manufacture a split core whose ease of assembly is improved, by using a compressed powder magnetic core.

The stator core of the present invention is a stator core which is disposed around the rotating shaft of a motor, wherein the stator core is formed of a plurality of split cores which are split in the circumferential direction; each split core is formed of a compressed powder magnetic core into a shape having a structure for connection with adjacent split cores; and the adjacent split cores are connected by means of the connection structure.

The stator core configures the motor stator together with the coil which is wound on it. In the motor, the rotor is rotated about the rotating shaft by an electromagnetic action between the rotor and the stator. The stator and the stator core are disposed to surround the rotating shaft (generally, outside of the rotor).

The stator is formed of a plurality of split cores which are split in a circumferential direction (the rotating direction of the rotor). Typically, the stator has an arc-shaped core back and a tooth of a protruding shape which extends from the core back toward the rotor, and each of the split cores is formed to include a single tooth or multiple teeth. The split core is formed to have a desired shape by being formed from a compressed powder magnetic core. In other words, it is formed to have a shape corresponding to a die by solidifying, in the die, a mixture of magnetic powder such as iron powder and an insulator such as a resin. Additional processing such as annealing may be performed to form the split cores.

At the time of formation, each split core is provided with a connection structure which is used for connection with its adjacent split core. In other words, the connection structure is formed simultaneously with formation of the compressed powder magnetic core by providing the die for forming the compressed powder magnetic core with a corresponding shape. Also, the adjacent split cores are connected by means of the connection structure.

By virtue of the above-described configuration, the necessity of performing press fitting or shrinkage fitting of the split cores into the housing according to the technology of the above-described JP-A 2004-328965 is eliminated, so that the space for the stator can be saved for the space of the housing. And, since a stress due to the connection of the split cores does not act on the magnetic powder of the split core, an increase in iron loss is prevented, and the characteristics of the stator can be improved. In addition, adoption of this connection embodiment allows simplification of the manufacturing process, because the connection structure is simultaneously formed at the time of forming, and secondary fabrication is not required.

According to an embodiment of the stator core of the invention, the connection structure of at least one pair of adjacent split cores (namely, two adjacent split cores, or multiple or all adjacent split cores) is a hole structure in which a fixing member is inserted, and the adjacent split cores are connected by means of the fixing member inserted into the hole structure. The hole structure may be a blind hole or a through hole. The hole structure may number only one, or multiple hole structures may be provided. By virtue of this configuration, the adjacent split cores can be connected easily by inserting the fixing member into the hole structure for fixing. The fixing member may be a separate member or a common member (a single member) for adjacent split cores.

According to an embodiment of the stator core of the invention, a common fixing member is inserted into the hole structures of the adjacent split cores to mutually connect the adjacent split cores. According to an embodiment of the stator core of the invention, the common fixing member is a clamp-type member having protruding parts, and the protruding parts are press-fitted into the individual hole structures to connect the adjacent split cores. The clamp-type member may be a “clamp” which simply connects two hole structures or connects three or more hole structures (or three or more split cores).

According to an embodiment of the stator core of the invention, the hole structures are disposed at mutually opposed locations, and the fixing member is a rod-shaped member which is inserted through both of the hole structures. Examples of the rod-shaped member include a bolt which is inserted by screwing into the hole structure.

According to an embodiment of the stator core of the invention, a separately formed connection member is used to connect the adjacent split cores, and the fixing member connects between the split core and the connection member to mutually connect the adjacent split cores. For example, the adjacent split cores can be connected by using a screw as the fixing member which is inserted into the hole structure to attach the connection member, which is made of a plate-like metal.

According to an embodiment of the stator core of the invention, the fixing member has a structure for attaching the stator to a casing for housing the motor. The motor is generally housed in the casing such that the stator and the like are not exposed. Therefore, it is necessary to attach a fitting for connecting the stator or the like and the casing, but this structure can be provided to the fixing member to eliminate a step required for disposing the fitting.

According to an embodiment of the stator core of the invention, at least one pair of adjacent split cores has the connection structure disposed at the end surfaces on the same side in a direction of the rotating shaft of the motor. In other words, the adjacent split cores are provided with the connection structure on the same side of the end surface of the front end side or the rear end side in the direction of the rotating shaft. Especially, in a case where the connection structure is provided at the end surfaces on the same side of all the split cores, the attaching step of the connection member can be facilitated considerably. Firm connection can be accomplished by disposing the connection structure at either end surface.

According to an embodiment of the stator core of the invention, at least one pair of adjacent split cores has a connection structure which is a structure to fit to a mating connection structure, and the adjacent split cores are mutually connected by fitting the connection structure. According to an embodiment of the stator core of the invention, the connection structure is a structure to fit to the mating connection structure in a direction of the rotating shaft of the motor. Typically, the connection structure of one of the split cores is determined to have a protruding shape, and the connection structure of the other split core is determined to have a recessed shape, so that they can be fitted to each other. It is also effective to configure the connection structure of both of the split cores to have a guiding rail shape and to slide it for fitting. Such fitting is convenient in view of simplification of the assembly process if it can be realized by relative movement of the adjacent split cores in a direction of the rotating shaft of the motor. In other words, the fitting direction is desirably determined to be the direction of the rotating shaft. The adjacent split cores may be provided with multiple pairs of fitting structures.

According to an embodiment of the stator core of the invention, the connection structure is a structure such that the fixing member is crimped, and the adjacent split cores are connected by crimping the fixing member to the connection structure. Here, crimping signifies the connection effected by hitting or tightening the connecting portion with a tool to plastically deform it. As a specific example, there is an embodiment in which the tool is brought into contact with the outer surface of a plate-like fixing member for application of pressure so as to press the fixing member into the connection structure for connection by crimping. To firmly connect the adjacent split cores by crimping, for example, the connection structure is provided on either end surface in the direction of the rotating shaft of the motor, and a fixing member which straddles both of the connection structures is crimped on both of the end surfaces. If very firm connection is not required, a separate connection member may be crimped in the vicinity of either end surface, or the connection member may be crimped in the vicinity of an end surface on one side only. The split core is provided with the connection structure for crimping at the position where the crimping is performed. The connection structure for crimping may be realized by, for example, a hole or a recess for enhancing the effect of the crimping, or by lowering its vicinity to a level lower than its circumference such that the crimped fixing member does not become an obstacle.

The motor of the invention is formed by employment of any of the above stator cores. No particular limitations are imposed on the type and size of he motor. For example, the stator core can also be applied to an AC motor (typically, a three-phase motor) which is widely used to drive a vehicle such as an electric vehicle or a hybrid vehicle. Also, a method of manufacturing a stator according to the invention comprises forming from a compressed powder magnetic core a plurality of split cores, which are split in the circumferential direction, into a shape having a structure for connection with adjacent split cores; mounting a coil on the formed split cores; and assembling the coil-mounted split cores into an annular form by connecting them by means of the connection structure.

### BRIEF DESCRIPTION OF THE DRAWINGS

FIG. 1 is a perspective view schematically showing an example of an overall structure of a motor.

FIG. 2 is a perspective view showing an example configuration for connecting split cores.

FIG. 3 is a perspective view showing another example configuration for connecting the split cores.

FIG. 4 is a perspective view showing another example configuration for connecting the split cores.

FIG. 5 is a sectional view for illustrating the example configuration of FIG. 4.

FIG. 6 is a perspective view showing another example configuration for connecting the split cores.

FIG. 7 is a diagram for illustrating a modified embodiment of the example connection configuration of FIG. 6.

FIG. 8 is a perspective view showing another example configuration for connecting the split cores.

FIG. 9 is a diagram for illustrating a modified embodiment of the example connection configuration of FIG. 2.

### BEST MODE FOR CARRYING OUT THE INVENTION

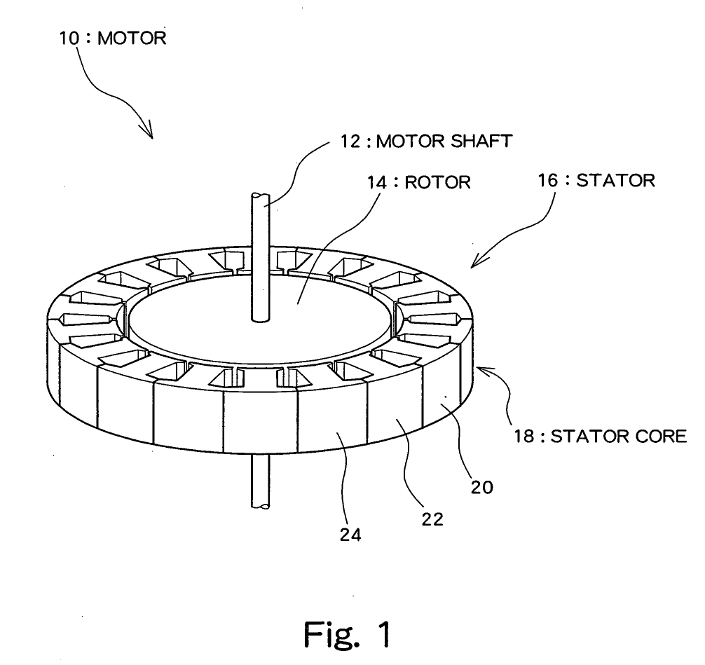

FIG. 1 is a perspective view schematically showing a structure of a motor 10 according to an embodiment of the invention. The motor 10 is provided with a motor shaft 12 which transmits rotation power to the outside, and the motor shaft 12 is disposed along the rotating shaft of a rotor 14. The rotor 14 is provided with a permanent magnet or an electromagnet and rotated by magnetic interaction with a stator which is disposed around it. Moreover, a stator 16 is provided with a stator core 18 formed of a compressed powder magnetic core, and a coil (not shown for the sake of simplifying the drawing) which is wound on the stator core 18. When electric current flows through the coil, the stator 16 functions as a magnetic pole.

The stator core 18 is configured by combining a plurality of split cores 20, 22, 24, . . . which are split in the circumferential direction of the rotating shaft. Specifically, the stator core 18 is formed of the split cores 20, 22, 24, . . . , which are formed of compressed powder magnetic cores, wound by a coil and connected into a cylindrical shape.

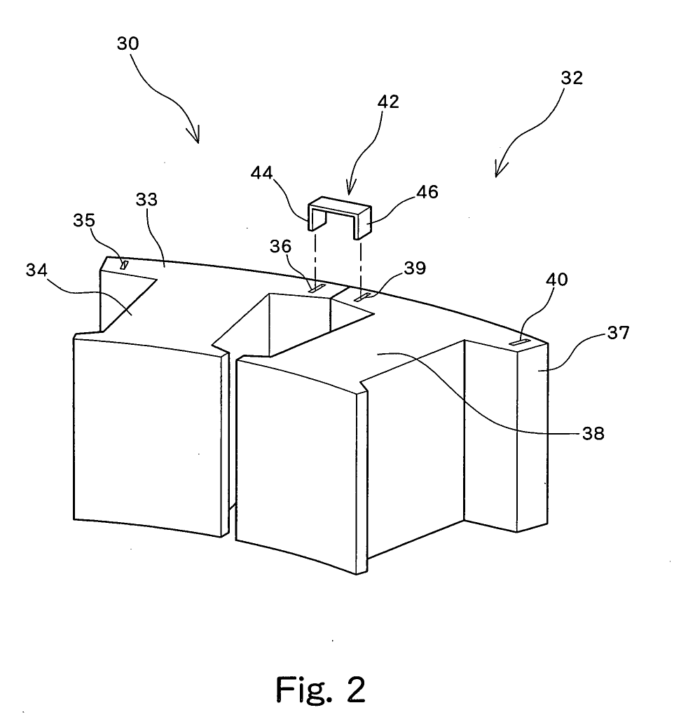

FIG. 2 is a perspective view for illustrating an example configuration for connecting the split cores 30, 32 which are parts of the stator core 18. The split core 30 is formed of a core back 33 which forms an outer circumference of the cylindrical shape, and a tooth 34 which protrudes from the core back toward the rotation center. The tooth 34 is wound by the coil so as to be come a magnetic pole corresponding to the electric current passing through the coil. Also, hole sections 35, 36 having a rectangular parallel piped shape are formed as a structure for connection with adjacent split cores near both ends on the top surface of the core back 33. The hole sections 35, 36 are formed to meet the corresponding protruded shapes which are formed in a die for forming the compressed powder magnetic core.

Similarly, the split core 32 is provided with a core back 37 and a tooth 38. In addition, hole sections 39, 40 are formed near both ends on the top surface of the core back 37.

The split cores 30, 32 are assembled with the mutual core backs 33, 37 adjacent to each other. A clamp 42 is used to assemble them. The clamp 42 is a square U-shaped metal member which has protruding sections 44, 46 at its respective ends. The protruding sections 44, 46 are press-fitted into the hole section 36 of the split core 30 and the hole section 39 of the split core 32. Thus, the adjacent split cores 30, 32 are fixed to each other.

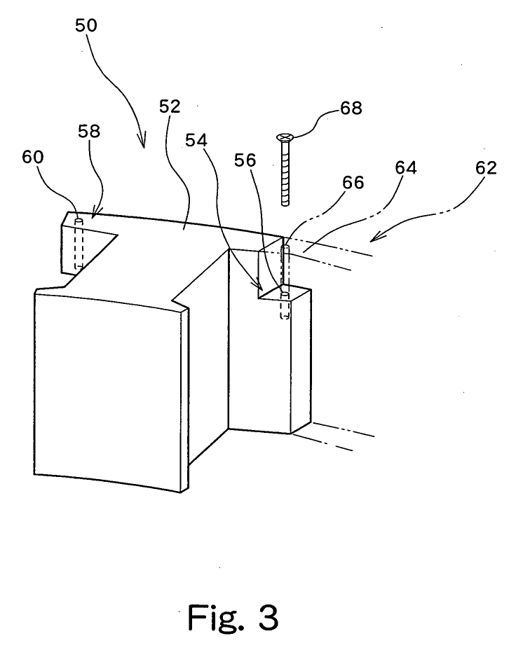

The adjacent split cores can also be mutually connected by various other methods. A plurality of modified examples are described below with reference to FIG. 3 through FIG. 9.

A split core 50 shown in FIG. 3 has a basic shape which is similar to those of the split cores 30, 32 shown in FIG. 2. However, a core back 52 is not provided with the hole sections shown in FIG. 2 but instead is provided with a cut-off portion 54 of a rectangular parallelpiped shape at one end on the top side of the core back 52 (as viewed in a direction of the rotating shaft of the motor). Also, the cut-off portion 54 is provided with a cylindrical hole section 56 which extends downward. A projecting section 58 is formed at the other end on the top side of the core back 52, and a cylindrical hole section 60 is formed in the vertical direction through the projecting section 58.

The split core 50 is assembled to come into contact with a split core 62 having the same shape. In other words, a projecting section 64 of the split core 62 is placed on the cut-off portion 54 of the split core 50. The hole section 56 which is formed in the cut-off portion 54 is coaxial with a hole section 66 which is formed in the projecting section 64. A long bolt 68 is downwardly screwed into the hole sections 56, 66. Thus, the adjacent split cores 50, 62 are mutually fixed. The cut-off portion and the projecting section may be formed on the bottom side of the split core.

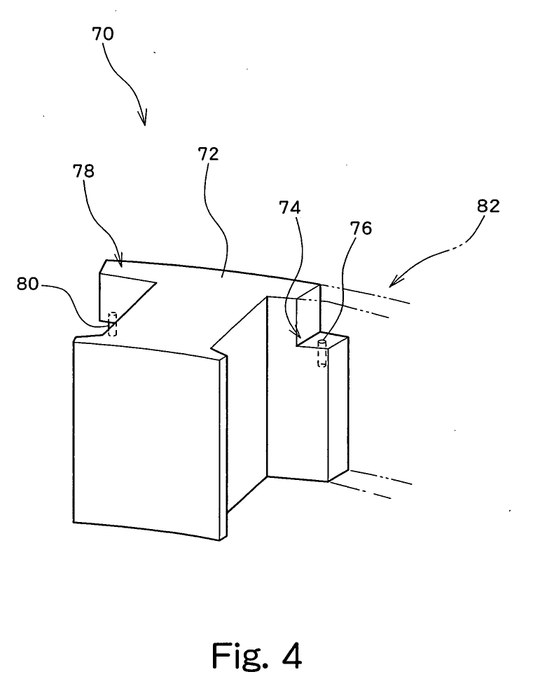

A split core 70 shown in FIG. 4 has substantially the same shape as that of the split core 50 shown in FIG. 3. In other words, a cut-off portion 74 is formed at one end on the top side of a core back 72, and a cylindrical hole section 76 is formed to extend downward into the cut-off portion 74. Also, a projecting section 78 is formed at the other end on the top side of the core back 72. However, the projecting section 78 does not have a through hole but has instead has a cylindrical protrusion 80 which extends downward from the bottom side of the projecting section 78.

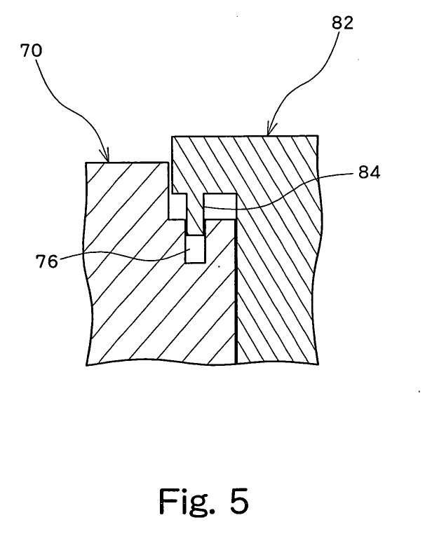

The split core 70 is assembled to come into contact with a split core 82 having the same shape. FIG. 5 is a sectional view for illustrating the connection of the split cores 70, 82. Here, a cylindrical protrusion 84 which is formed on the split core 82 is inserted downwardly into the cylindrical hole section 76 which is formed in the split core 70. Thus, the hole section 76 and the protrusion 84 are fitted firmly, and the split cores 70, 82 are connected accordingly.

The embodiment of connection by fitting can be applied to a connection of all adjacent split cores. However, the split core to be assembled last cannot be inserted between its adjacent split cores, because such insertion is hindered by their shapes. Therefore, there may be employed a configuration where the split core that is assembled last is provided with a hole section or a protrusion at either end instead of being provided with the hole section and the protrusion. Alternatively, it is also effective to dispose, for example, the split cores having the hole section at either end and the split cores having the protrusion at either end alternately, except for the last split core. For the last split core, the connection embodiment using the bolt described with reference to FIG. 2 may be adopted.

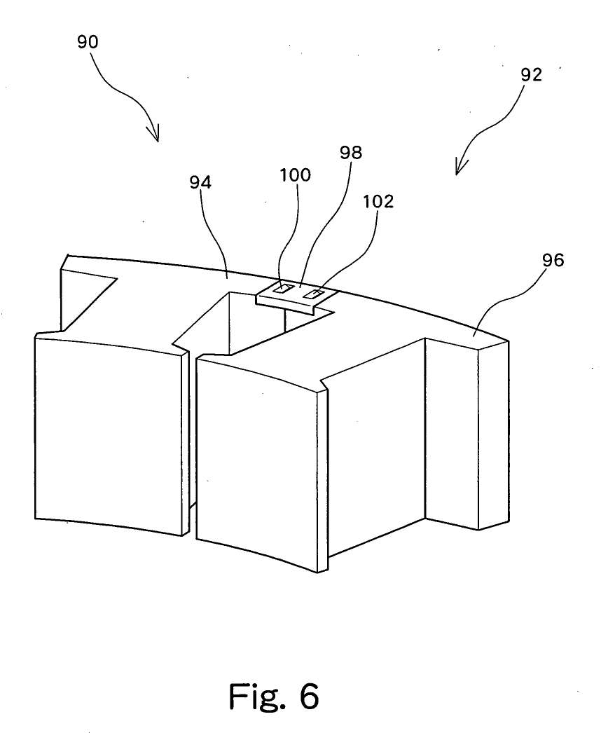

Split cores 90, 92 shown in FIG. 6 have the same basic shape as that of the split cores 30, 32 shown in FIG. 2. However, this example does not adopt the connection employing the rectangular parallelpiped shape hole section and the clamp. Instead, a core back 94 of the split core 90 and a core back 96 of the split core 92 are connected by a crimping member 98.

The crimping member 98 is a square U-shaped plate-like member which is disposed on the top surfaces of the core backs 94, 96. The crimping member 98 is pressed from above by means of a tool and plastically deformed together with the core back underneath it so as to be connected by crimping. In other words, the core back 94 and the crimping member 98 are connected via a recess 100 of the core back 94, and the core back 96 and the crimping member 98 are connected via a recess 102 of the core back 96. As a result, the split cores 90, 92 are mutually connected by the crimping member. It is effective to provide the crimping positions of the core backs 94, 96 with a structure for assuring the crimping by forming a recessed shape in advance.

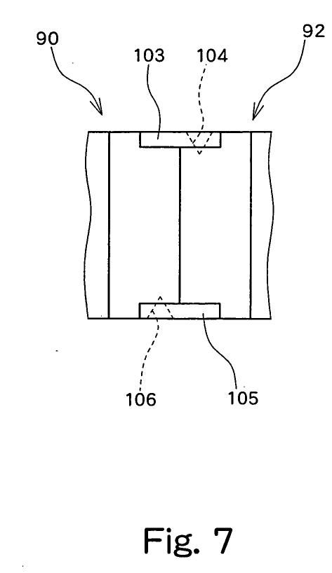

The crimping can be performed in various ways. FIG. 7 is a diagram showing a modified example of the embodiment of connecting the core backs by crimping, showing the vicinity of the connected portion of the split cores 90, 92 shown in FIG. 6 as viewed from the side of the rotation center. According to this embodiment, the split cores 90, 92 are crimped on the top side and bottom side of the core backs 94, 96. In other words, a square U-shaped crimping member 103 is disposed on the top side to straddle the split cores 90, 92. It is pressed from above and crimped on the side of the split core 92. Meanwhile, a square U-shaped crimping member 105 is disposed to straddle the split cores 90, 92 on the bottom side and crimped on the side of the split core 90. Thus, both the split cores 90, 92 are firmly connected by the two crimping members 103, 106.

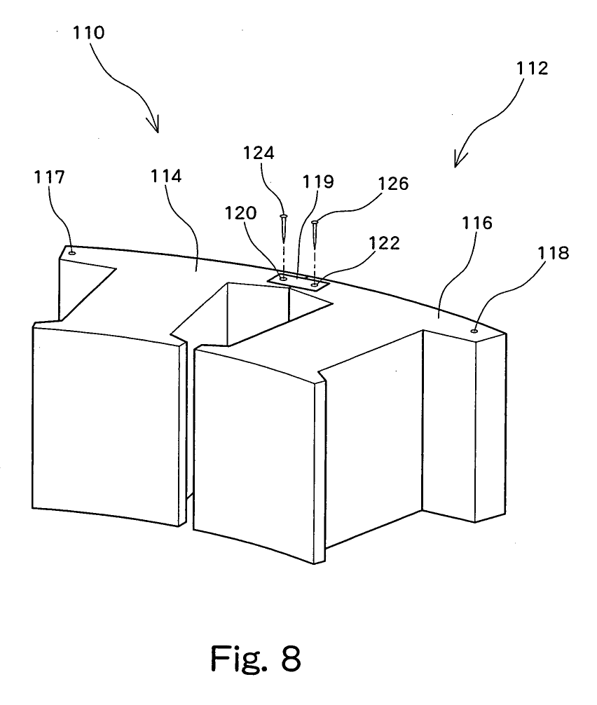

Split cores 110, 112 shown in FIG. 8 have the same basic shape as that of the split cores 30, 32 shown in FIG. 2. However, this example does not adopt the connection by means of the hole section of a rectangular parallelpiped shape and the clamp 42. Instead, screw-receiving openings 117, 118 are formed in respective ends on the top sides of core backs 114, 116. Moreover, a metal plate 119 serving as a connection member straddles over the screw-receiving openings. The metal plate 119 is provided with screw holes 120, 122 for insertion of screws. Screws 124, 126 are screwed into the screw-receiving openings through the screw holes 120, 122 to mutually connect the split cores 110, 112 via the metal plate 119.

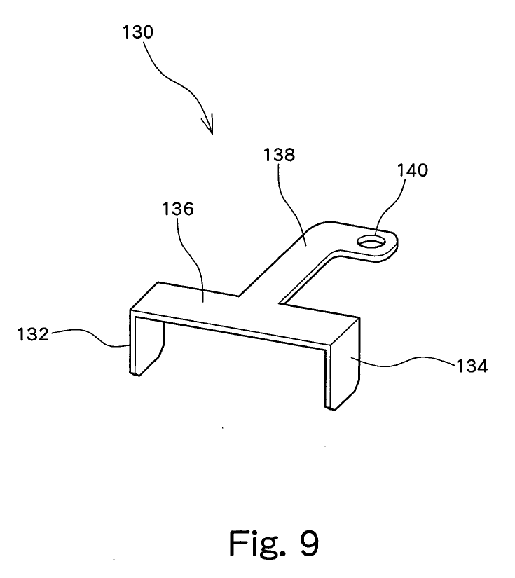

A clamp 130 shown in FIG. 9 illustrates an example modification of the structure of the clamp 42 shown in FIG. 2. Similar to the clamp 42, the clamp 130 has protruding sections 132, 134 at respective ends, which are inserted into the hole sections to mutually connect the split cores. A branch portion 138 extends from the vicinity of the center of a plate-like section 136 which mutually connects the protruding sections 132, 134. Meanwhile, a bolt hole 140 is formed at a leading end of the branch portion 138.

The bolt hole 140 is used to dispose the stator on the casing which surrounds the motor. Generally, the outer surface of the motor is at least partially covered with the casing. Therefore, a certain type of member for connecting the motor and the casing is required. Here, the clamp 130 also serves as the connection member to simplify the manufacturing process and the motor structure.

1. A stator core which is disposed around the rotating shaft of a motor, wherein:
the stator core is formed of a plurality of split cores which are split in the circumferential direction;
each split core is formed of a compressed powder magnetic core into a shape having a structure for connection with adjacent split cores; and
the adjacent split cores are connected by means of the connection structure.

2. The stator core according to claim 1, wherein:
at least one pair of adjacent split cores has the connection structure which is a hole structure into which a fixing member is inserted; and
the adjacent split cores are connected by means of the fixing member which is inserted into the hole structure.

3. The stator core according to claim 2, wherein a common fixing member is inserted into the hole structures of the adjacent split cores to mutually connect the adjacent split cores.

4. The stator core according to claim 3, wherein the fixing member is a clamp-type member having protruding sections, and the protruding sections are press-fitted into the individual hole structures to connect the adjacent split cores.

5. The stator core according to claim 3, wherein:
the hole structures are formed at mutually opposed positions; and
the fixing member is a rod-shaped member which is inserted through both the hole structures.

6. The stator core according to claim 2, wherein:
a separately formed connection member is used to connect the adjacent split cores; and
the fixing member connects the split core and the connection member to mutually connect the adjacent split cores.

7. The stator core according to claim 2, wherein the fixing member is provided with a structure for attaching a stator to a casing for housing the motor.

8. The stator core according to claim 1, wherein at least one pair of adjacent split cores has the connection structure which is disposed at the end surfaces on the same side in a direction of the rotating shaft of the motor.

9. The stator core according to claim 1, wherein:
at least one pair of adjacent split cores has the connection structure which is a structure to fit to a mating connection structure; and
the adjacent split cores are mutually connected by fitting the connection structures.

10. The stator core according to claim 9, wherein the connection structure has a structure to fit to the mating connection structure in a direction of the rotating shaft of the motor.

11. The stator core according to claim 1, wherein:
the connection structure is a structure for crimping the fixing member; and
the adjacent split cores are connected by crimping the fixing member to the connection structure.

12. A motor which has the stator core according to claim 1.

13. A method of manufacturing a stator which is disposed around the rotating shaft of a motor, comprising:
forming from a compressed powder magnetic core a plurality of split cores, which are split in the circumferential direction, into a shape having a structure for connection with adjacent split cores;
mounting a coil on the formed split cores; and
assembling the coil-mounted split cores into an annular form by connecting them by means of the connection structure.
